(19) United States
(12) Patent Application Publication
(10) Pub. No.: US 2004/0188997 A1
(43) Pub. Date: Sep. 30, 2004

(54) Lottery ticket

(76) Inventors: Lyle Harold Scrymgeour, Winnipeg (CA); Michael John Brickwood, Winnipeg (CA); Blaine Reimer, Winnipeg (CA)

Correspondence Address: ADE & COMPANY, 1700-360 MAIN STREET, WINNIPEG, MB, R3C3Z3, CA

(21) Appl. No.: 10/394,570

(22) Filed: Mar. 24, 2003

(51) Int. Cl. B42D 15/00

(52) U.S. Cl. 283/100

(57) ABSTRACT

Described herein is a break-open lottery ticket where the ticket is formed by laminating two substrate sheets. The lottery ticket includes variable imaged lottery indicia printed directly onto the inside surface of both sheets the ticket and covered by a layer of scratch-off material. The indicia and the scratch-off material are enclosed within the sheets allowing the outside surfaces to be used for game and promotional information. Either just the first substrate sheet or both sheets are perforated to define a perforated tear line thereon arranged to define a portion of the first substrate sheet which can be opened relative to the second substrate sheet, by the player tearing through the perforated tear line, to expose game data. The perforated tear line defining the portion extends only part way around the periphery of the portion of the first substrate sheet so that when the perforation lines are torn the portion of the first substrate sheet remains attached to the second substrate sheet. This provides a larger or double game area on the inside surfaces which can be used for a larger and more complex single game.

The present invention relates generally to the field of lottery tickets and more particularly to a combined ticket assembly which is formed in two laminated sections which can be opened.

### BACKGROUND OF THE INVENTION

Lottery tickets are well known and widely sold and typically comprise a sheet material of paper or card stock on which is printed lottery information and various indicia for the playing of one or more games. Many such games are instant win type games where the player can play the game or games by carrying out various functions, for example, opening pull tabs on a break-open ticket. Such tickets are also known variously as pull-tabs, pickle cards, jar tickets, hard cards and charitable gaming tickets.

Break-open tickets are typically constructed by printing a sheet containing multiple combinations of lottery indicia thereon. This sheet is then cut into sections. The opposite side of this sheet includes prize categories, serial number etc. A second sheet contains removable tabs or break-open windows is then mounted onto the card stock such that the break-open windows overlap the lottery indicia. However, break-opens prepared in this manner have the disadvantages that they are cumbersome to prepare, have a limited set of winning symbols and require manually checking at the time of redemption.

U.S. Pat. No. 4,174,857 (Koza) and U.S. Pat. No. 5,253,899 (Greenwood) each disclose a combined ticket construction in which a second layer is applied or folded over the basic ticket to improve security. U.S. Pat. No. 5,562,284 discloses a break-open ticket with a second level of break-open. U.S. Pat. No. 5,217,258 (Sanderson) discloses a two sided break-open ticket where the windows are arranged back to back opening onto a single center sheet carrying the game data.

As shown in published PCT International application No. WO 98/57715 published 23_{rd} Dec. 1998 of the present applicants there is provided a pouched lottery ticket which is supplied in a fan folded continuous strip arrangement for separating each ticket from the next at a dispensing station. The disclosure of this publication may be referred to for further information.

Also in the prior art is a sample of a game ticket manufactured by Scientific Games and known under the trademark “Zip-Tix”. This comprises a ticket formed of a paper back sheet with a foil or metalized front sheet. The front sheet has a single break-open window which can be torn open to reveal a black printed image of game indicia printed onto a grey security coating. The printed image includes a validation number printed under the break-open window so that it is revealed when the window is opened. The game indicia appear to be printed using an ink jet system. What appears to be a validation number is printed below the game data.

In U.S. Pat. No. 6,234,477 assigned to the present assignee and issued May 22^{nd} 2001 is disclosed a construction of lottery ticket which utilizes variable image printing techniques in combination with lamination of two substrate sheets together to form what is initially a common pouch construction with the game indicia on the inside surface where the sheets can be separated from each from the other to form in effect two separate tickets.

### SUMMARY OF THE INVENTION

It is one object of the present invention to provide a lottery ticket arrangement which provides a larger common surface area on which a larger and more complex game or games can be applied.

According to a lottery ticket construction for playing by a player comprising:

a first substrate sheet material having a front surface and a rear surface;

a second substrate sheet material having a front surface and a rear surface;

promotional graphics printed on said front surface of at least one of the first and second substrate sheets;

lottery game information printed on said front surface of at least one of the first and second substrate sheets;

first lottery game indicia printed by variable image printing onto said rear surface of said first substrate sheet, at least some of the first lottery game indicia being covered by a layer of scratch-off material removable by the player;

second lottery game indicia printed by variable image printing onto said rear surface of said second substrate sheet, at least some of the second lottery game indicia being covered by a layer of scratch-off material removable by the player;

the first and second substrates being coextensive with the rear surface of the first substrate sheet being connected to the rear surface of the second substrate sheet to form a common ticket assembly;

at least the first substrate sheet being perforated to define a perforated tear line thereon arranged to define a portion of the first substrate sheet which can be opened relative to the second substrate sheet, by the player tearing through the perforated tear line, to expose the scratch-off material covering the lottery game indicia on the rear surface of the second substrate sheet and to expose the scratch-off material covering the lottery game indicia on the rear surface of the portion of the first substrate sheet;

the perforated tear line defining the portion extending only part way around the periphery of the portion of the first substrate sheet leaving a part of the periphery of the portion of the first substrate sheet which is free from the tear line at which the portion of the first substrate sheet remains attached to the second substrate sheet.

In the preferred arrangement, the first substrate sheet includes only a single portion which can be opened relative to the second sheet, but other arrangements may be provided where two or more portions are provided which can be opened relative to the second sheet.

In order to maximize the area available on the inside surfaces for the game data, the portion of the first substrate sheet forms substantially the whole of the first substrate sheet leaving only a narrow peripheral portion, thus providing substantially the whole of the inside surfaces of both sheets for the game data and in effect, doubling the area available relative to the surface area of the base ticket construction. However in a ticket construction where the maximum area is not required, the portion may formal smaller part of the ticket.

In one arrangement, only the first substrate sheet is perforated leaving the second substrate sheet free from the perforated tear line such that the portion of the first substrate sheet is separated from the second substrate sheet at the tear line and opened relative to the second substrate sheet leaving edge portions of the first substrate sheet attached to the second substrate sheet. This has the advantage that the whole ticket remains intact and there are no loose or separate pieces which can be discarded as trash in unsuitable places. However this has the disadvantage that the perforation lines must be relatively weak to allow the tearing action to occur and this can allow the ticket to break open during handling or dispensing from a dispensing machine, thus detracting from the appearance and potentially decreasing the security. In particular, some dispensing machines use a roller around which the tickets in a connected strip of the tickets pass where the curvature around the roller tends to burst open the perforation lines transverse to the feed direction due to the tendency to stretch the substrate sheet on the outside of the curvature.

In some cases the portion of the first substrate sheet is substantially rectangular and the perforated tear line is formed from three portions arranged mutually at right angles. However other shapes are possible including complex shapes formed as “die cut” tickets. In this case the perforation line may be a complex line including straight and curved sections.

In another construction, both the first and second substrate sheets are weakened, generally but not necessarily by perforations along at least a part of the perforated tear line such that an edge portion of both the first and second substrate sheets can be folded relative to the portion of the first substrate sheet to assist in breaking the perforations. This allows the use of the perforation line which is less aggressively cut so that it retains a stronger connection because the ticket can be folded by the player at the line to assist in fracturing. This may assist in providing a line which can be more readily separated by the player. This may assist in allowing the stronger perforation line to more readily pass through the dispensing machine and pass over rollers in such a machine. This has the disadvantage that, when fully perforated through both sheets, the torn edge portions become separate and thus may be dropped as garbage.

In order to best pass through the dispensing machine it is preferred that, where the portion of the first substrate sheet has ends at respective ends of the common ticket construction, the part of the periphery which is free from the tear line is at one end and a part only of the perforated tear line, where both the first and second substrate sheets are perforated, is at the opposed end.

In some cases, both the first substrate sheet and second substrate sheet are perforated along the whole of the perforated tear line such that edge portions of both the first and second substrate sheets can be separated from the portion of the first substrate sheet.

In some cases, the lottery game indicia on the rear surface of the first substrate sheet are associated with the lottery game indicia on the rear surface of the second substrate sheet to form a common lottery game.

According to a second aspect of the invention there is provided a lottery ticket construction for playing by a player comprising:

a first substrate sheet material having a front surface and a rear surface;

a second substrate sheet material having a front surface and a rear surface;

promotional graphics printed on said front surface of at least one of the first and second substrate sheets;

lottery game information printed on said front surface of at least one of the first and second substrate sheets;

first lottery game indicia printed by variable image printing onto said rear surface of said first substrate sheet, at least some of the first lottery game indicia being covered by a layer of scratch-off material removable by the player;

second lottery game indicia printed by variable image printing onto said rear surface of said second substrate sheet, at least some of the second lottery game indicia being covered by a layer of scratch-off material removable by the player;

the first and second substrates being coextensive with the rear surface of the first substrate sheet being connected to the rear surface of the second substrate sheet to form a common ticket assembly;

the first substrate sheet and second substrate sheet being perforated to define a perforated tear line extending through the common ticket assembly;

the perforated tear line being arranged to define edge portions of the common ticket assembly which can be torn away, by the player tearing through the perforated tear line, from overlying portions of the first and second substrate sheets;

such that the overlying portions thus can be opened to expose the scratch-off material covering the lottery game indicia on the rear surface of the second substrate sheet and to expose the scratch-off material covering the lottery game indicia on the rear surface of the portion of the first substrate sheet;

the perforated tear line defining the overlying portions extending only part way around the periphery of the overlying portions leaving a part of the periphery of the portion of the first substrate sheet which is free from the tear lines at which the portion of the first substrate sheet remains attached to the second substrate sheet.

It is a further object of the present invention to provide a lottery ticket arrangement which forms two ticket portions which are overlying and laminated together in an initial condition but which can be opened, and particularly to provide a construction which improves the technique for opening.

According to a third aspect of the invention there is provided a lottery ticket construction for playing by a player comprising:

a first substrate sheet material having a front surface and a rear surface;

a second substrate sheet material having a front surface and a rear surface;

promotional graphics printed on said front surface of at least one of the first and second substrate sheets;

lottery game information printed on said front surface of at least one of the first and second substrate sheets;

first lottery game indicia printed by variable image printing onto said rear surface of said first substrate sheet, at least some of the first lottery game indicia being covered by a layer of scratch-off material removable by the player;

second lottery game indicia printed by variable image printing onto said rear surface of said second substrate sheet, at least some of the second lottery game indicia being covered by a layer of scratch-off material removable by the player;

the first and second substrates being coextensive with the rear surface of the first substrate sheet being connected to the rear surface of the second substrate sheet to form a common ticket assembly;

the first substrate sheet and second substrate sheet both being perforated to define a perforated tear line extending through the common ticket assembly;

the perforated tear line being arranged to define edge portions of the common ticket assembly which can be torn away, by the player tearing through the perforated tear line, from overlying portions of the first and second substrate sheets;

such that the overlying portions thus can be opened to expose the scratch-off material covering the lottery game indicia on the rear surface of the second substrate sheet and to expose the scratch-off material covering the lottery game indicia on the rear surface of the portion of the first substrate sheet.

### BRIEF DESCRIPTION OF THE DRAWINGS

One embodiment of the invention will now be described in conjunction with the accompanying drawings in which:

FIG. 1 is a front elevational view of one example of lottery ticket according to the present invention showing the front surface of first substrate sheet.

FIG. 2 is a cross sectional view of the lottery ticket of FIG. 1.

FIG. 3 is a front view of the lottery ticket of FIG. 1 showing the ticket in the opened condition.

FIG. 4 is a front elevational view of a second example lottery ticket.

FIG. 5 is a cross sectional view of the lottery ticket of FIG. 4.

In the drawings like characters of reference indicate corresponding parts in the different figures.

### DESCRIPTION OF THE PREFERRED EMBODIMENTS

The construction of the game tickets and the method of manufacture thereof is similar to that shown in U.S. Pat. No. 6,234,477 of the present assignee, the disclosure of which is incorporated herein by reference from which further details of the construction can be obtained.

However the construction is modified, in one respect, so that it provides a single ticket construction which can be opened to expose game data on the inside surfaces of the first and second substrate sheets while the substrate sheets remain connected along a fold line.

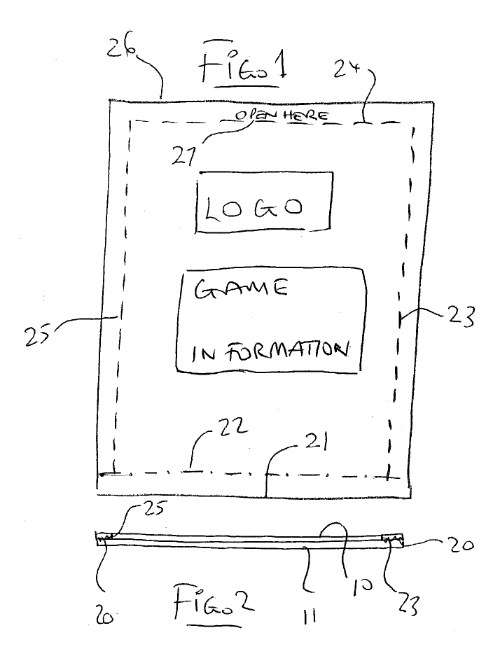

Thus a first example is shown in FIG. 1 where the ticket construction is formed from a first substrate 10 and a second substrate 11 which are arranged in coextensive overlying relationship using the methods as described in the above patent.

On the inside surfaces 12 and 13 of the first and second substrates respectively is provided game data 14A and 14B of a game generally indicated at 14 so that when the ticket is opened as shown in FIG. 3 the full area of the inside surfaces of both substrate sheets is available for a single game or for multiple games as required, that area being substantially equal to double the area of the ticket when supplied as shown in FIG. 1.

Also on the inside surface of one of the substrate sheets is provided a game validation number 15 and a barcode 16.

The game data can be of various different types well known to one skilled in the art and generally will include a scratch-off coating which may be opaque or translucent depending upon the type of game. In all cases the player after opening the ticket to the condition shown in FIG. 3 plays the game using well known techniques to expose or mark certain areas of the game data by scratching the scratch-off coating thus revealing the ticket to be a winning or losing ticket according to predetermined characteristics.

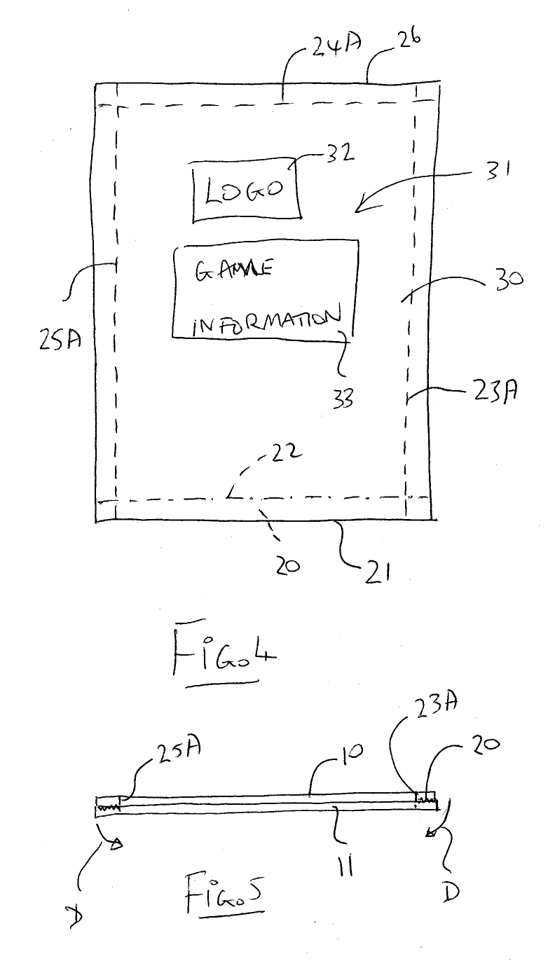

As shown in FIGS. 1 and 4 a front, or outside, surface 30 of the first substrate sheet 10 includes promotional information 31 including a logo or game name 32 and game information 33. The outside surface of the second substrate sheet may include further game information as is well known to one skilled in this art.

The substrate sheets 10 and 11 are laminated together around the outside edge by adhesive 20 leaving a central area of each sheet free from the adhesive and thus free to separate to expose the game data as shown in FIG. 3. The adhesive 20 is applied around all four sides of the rectangular ticket.

One end edge 21 of the ticket is preferably arranged so that the substrate sheets remain connected along that edge by the adhesive 20 along that edge perform a fold line 22 at the inside edge of the adhesive strip 20. The fold line is shown in chain dot line in FIG. 1 and in full line in FIG. 3 after the folding has occurred with the ticket open.

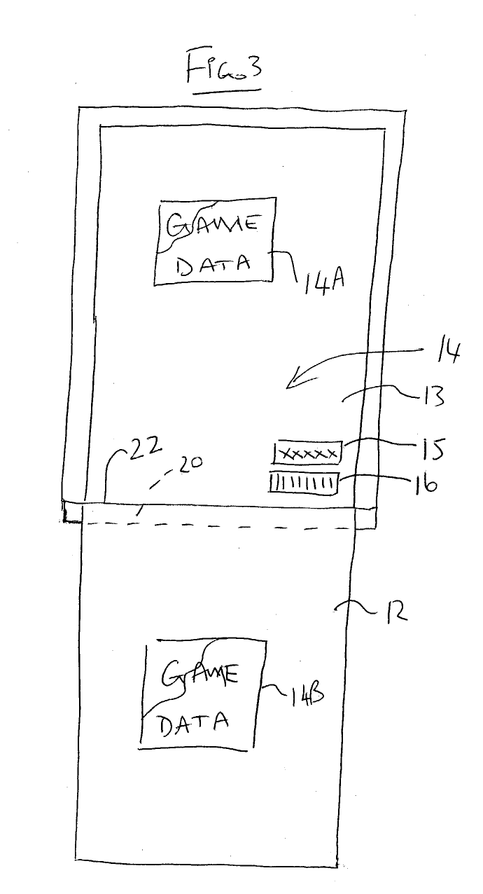

The other three sides of the ticket are defined by perforation lines 23, 24 and 25. As shown in FIG. 2, the perforation lines 23,24 and 25 are formed only in the first sheet 10 and are not provided in the second sheet 11. Also in this arrangement the perforation lines do not extend to the edges of the ticket but are instead confined to the area inside the adhesive 20 to form a line extending from the fold line 22 around the periphery of the ticket just inside the adhesive 20.

Thus in this arrangement, the player inserts a finger into the line of perforation at the end 26 opposite to the fold line 22 at the location indicated at 27 and then carefully tears around the perforation lines to separate the portion of the first sheet inside the fold lines from the second sheet allowing the first sheet to be opened into the positions shown in FIG. 3.

In the arrangement shown in FIG. 4 and also shown in cross section in FIG. 5, the lines of perforation as indicated at 23A, 24A and 25A extend right to the edges of the ticket so that for example the perforation lines 23A and 25A extend from the edge 21 through the edge 26. In addition the line of perforation are formed through both substrate sheets as shown in FIG. 5.

In this arrangement, the player is instructed to open the ticket by folding the edge portions defined by the adhesively connected edge portions of the first and second substrate about the perforation lines causing the perforation lines to fracture and allow the tearing of the portions away from the remaining ticket construction. Thus the three edge portions defined by the lines 23A, 24A and 25A can be folded back and forth and torn away leaving only the center portion of the first sheet and the center portion of the rear sheet which can then be opened to expose the game data on the inside surfaces for playing by the player.

In an alternative arrangement (not shown), the perforations can be formed through the upper sheet and partly into the lower sheet forming a line of weakness in the lower sheet which is less than the weakness formed by full perforation. In this way the folding action can occur in the downward direction as shown in FIG. 5 indicated at arrows D which acts to fracture the perforation line in the upper sheet allowing the player to readily open the ticket by tearing along the fold lines through the perforations in the upper sheet to take up the position shown in FIG. 3.

The use of an arrangement with perforations in the upper sheet which allows folding of the edges allows the perforation lines to be stronger in character since they can be more readily fractured by the folding action. The stronger perforations thus reduce the tendency of the perforations to break open when passing around a roller with the upper sheet outermost.

As the tickets generally travel around the roller in the direction along the length of the ticket so that the edges 21 and 26 are transverse to the direction of movement, it is more important that the perforation line 24A is of increased strength preventing cracking. Thus the edge 21 with the fold line 22 lies along one transverse line and cannot be cracked open since it is not perforated. Thus the opposite edge 26 includes a strong perforation line reducing the possibility of tracking. The side edges can then include perforation lines 23 and 25 which are of reduced strength of the type shown in FIG. 1 since they have reduced tendency to crack.

The above arrangement of FIGS. 4 and 5 provides the perforated lines of weakness along three of the sides with the fourth side defined by the fold line 22. However it is also possible to use this opening technique to fully separate the two ticket portions by forming the line 22 also as a perforated line of weakness through both the first and second substrates. In this case, all four sides strip are folded to crack the line of weakness and then are torn away. Thus the arrangement described herein provides perforated lines of weakness on at least three sides for opening or separating the two substrates to expose the game data on the inside surfaces.

While the preferred embodiments of the invention have been described above, it will be recognized and understood that various modifications may be made therein, and the appended claims are intended to cover all such modifications which may fall within the spirit and scope of the invention.

1. A lottery ticket construction for playing by a player comprising:
a first substrate sheet material having a front surface and a rear surface;
a second substrate sheet material having a front surface and a rear surface;
promotional graphics printed on said front surface of at least one of the first and second substrate sheets;
lottery game information printed on said front surface of at least one of the first and second substrate sheets;
first lottery game indicia printed by variable image printing onto said rear surface of said first substrate sheet, at least some of the first lottery game indicia being covered by a layer of scratch-off material removable by the player;
second lottery game indicia printed by variable image printing onto said rear surface of said second substrate sheet, at least some of the second lottery game indicia being covered by a layer of scratch-off material removable by the player;
the first and second substrates being coextensive with the rear surface of the first substrate sheet being connected to the rear surface of the second substrate sheet to form a common ticket assembly;
at least the first substrate sheet being perforated to define a perforated tear line thereon arranged to define a portion of the first substrate sheet which can be opened relative to the second substrate sheet, by the player tearing through the perforated tear line, to expose the scratch-off material covering the lottery game indicia on the rear surface of the second substrate sheet and to expose the scratch-off material covering the lottery game indicia on the rear surface of the portion of the first substrate sheet;
the perforated tear line defining the portion extending only part way around the periphery of the portion of the first substrate sheet leaving a part of the periphery of the portion of the first substrate sheet which is free from the tear line at which the portion of the first substrate sheet remains attached to the second substrate sheet.

2. The lottery ticket construction according to claim 1 wherein the first substrate sheet includes only a single portion which can be opened.

3. The lottery ticket construction according to claim 1 wherein the portion of the first substrate sheet forms substantially the whole of the first substrate sheet leaving only a narrow peripheral portion.

4. The lottery ticket construction according to claim 1 wherein only the first substrate sheet is perforated leaving the second substrate sheet free from the perforated tear line such that the portion of the first substrate sheet is separated from the second substrate sheet at the tear line and opened relative to the second substrate sheet leaving edge portions of the first substrate sheet attached to the second substrate sheet.

5. The lottery ticket construction according to claim 1 wherein the portion of the first substrate sheet is substantially rectangular and the perforated tear line is formed from three portions arranged mutually at right angles.

6. The lottery ticket construction according to claim 1 wherein second substrate sheet is weakened along at least a part of the perforated tear line such that an edge portion of both the first and second substrate sheets can be folded relative to the portion of the first substrate sheet.

7. The lottery ticket construction according to claim 6 wherein second substrate sheet is weakened along at least a part of the perforated tear line by perforations such that the edge portion of both the first and second substrate sheets can be torn away from the portion of the first substrate sheet.

8. The lottery ticket construction according to claim 6 wherein the portion of the first substrate sheet has ends at respective ends of the common ticket construction and wherein the part of the periphery which is free from the tear line is at one end and the part of the perforated tear line, where the second substrate sheets is weakened, is at the opposed end.

9. The lottery ticket construction according to claim 1 wherein both the first substrate sheet and second substrate sheet are perforated along the perforated tear line such that edge portions of both the first and second substrate sheets can be separated from the portion of the first substrate sheet.

10. The lottery ticket construction according to claim 1 wherein the lottery game indicia on the rear surface of the first substrate sheet are associated with the lottery game indicia on the rear surface of the second substrate sheet to form a common lottery game.

11. A lottery ticket construction for playing by a player comprising:
a first substrate sheet material having a front surface and a rear surface;
a second substrate sheet material having a front surface and a rear surface;
promotional graphics printed on said front surface of at least one of the first and second substrate sheets;
lottery game information printed on said front surface of at least one of the first and second substrate sheets;
first lottery game indicia printed by variable image printing onto said rear surface of said first substrate sheet, at least some of the first lottery game indicia being covered by a layer of scratch-off material removable by the player;
second lottery game indicia printed by variable image printing onto said rear surface of said second substrate sheet, at least some of the second lottery game indicia being covered by a layer of scratch-off material removable by the player;
the first and second substrates being coextensive with the rear surface of the first substrate sheet being connected to the rear surface of the second substrate sheet to form a common ticket assembly;
the first substrate sheet and second substrate sheet being perforated to define a perforated tear line extending through the common ticket assembly;
the perforated tear line being arranged to define edge portions of the common ticket assembly which can be torn away, by the player tearing through the perforated tear line, from overlying portions of the first and second substrate sheets;
such that the overlying portions thus can be opened to expose the scratch-off material covering the lottery game indicia on the rear surface of the second substrate sheet and to expose the scratch-off material covering the lottery game indicia on the rear surface of the portion of the first substrate sheet;
the perforated tear line defining the overlying portions extending only part way around the periphery of the overlying portions leaving a part of the periphery of the portion of the first substrate sheet which is free from the tear lines at which the portion of the first substrate sheet remains attached to the second substrate sheet.

12. The lottery ticket construction according to claim 11 wherein the overlying portions are rectangular with three edge portions each along a respective one of three edges thereof each of which can be torn away by the player.

13. The lottery ticket construction according to claim 11 wherein the portion of the first substrate sheet forms substantially the whole of the first substrate sheet leaving only the narrow edge portions.

14. The lottery ticket construction according to claim 11 wherein the lottery game indicia on the rear surface of the first substrate sheet are associated with the lottery game indicia on the rear surface of the second substrate sheet to form a common lottery game.

15. A lottery ticket construction for playing by a player comprising:
a first substrate sheet material having a front surface and a rear surface;
a second substrate sheet material having a front surface and a rear surface;
promotional graphics printed on said front surface of at least one of the first and second substrate sheets;
lottery game information printed on said front surface of at least one of the first and second substrate sheets;
first lottery game indicia printed by variable image printing onto said rear surface of said first substrate sheet, at least some of the first lottery game indicia being covered by a layer of scratch-off material removable by the player;
second lottery game indicia printed by variable image printing onto said rear surface of said second substrate sheet, at least some of the second lottery game indicia being covered by a layer of scratch-off material removable by the player;
the first and second substrates being coextensive with the rear surface of the first substrate sheet being connected to the rear surface of the second substrate sheet to form a common ticket assembly;
the first substrate sheet and second substrate sheet both being perforated to define a perforated tear line extending through the common ticket assembly;
the perforated tear line being arranged to define edge portions of the common ticket assembly which can be torn away, by the player tearing through the perforated tear line, from overlying portions of the first and second substrate sheets;
such that the overlying portions thus can be opened to expose the scratch-off material covering the lottery game indicia on the rear surface of the second substrate sheet and to expose the scratch-off material covering the lottery game indicia on the rear surface of the portion of the first substrate sheet.

16. The lottery ticket construction according to claim 15 wherein the overlying portions are rectangular with at least three edge portions each along a respective one of at least three edges thereof each of which can be torn away by the player.

17. The lottery ticket construction according to claim 15 wherein the portion of the first substrate sheet forms substantially the whole of the first substrate sheet leaving only the narrow edge portions.

18. The lottery ticket construction according to claim 15 wherein the lottery game indicia on the rear surface of the first substrate sheet are associated with the lottery game indicia on the rear surface of the second substrate sheet to form a common lottery game.
